(19) United States
(12) Patent Application Publication
(10) Pub. No.: US 2010/0085606 A1
(43) Pub. Date: Apr. 8, 2010

(54) SYSTEM AND METHOD FOR DOCUMENT RENDERING DEVICE RESOURCE CONSERVATION

(76) Inventor: Brenda Daos, Mission Viejo, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/244,360

(22) Filed: Oct. 2, 2008

(51) Int. Cl. G06K 15/00

(52) U.S. Cl. 358/3.24

(57) ABSTRACT

The subject application is directed to a document rendering device resource conservation system and method. Threshold parameter data of acceptable resource usage levels in an associated document rendering device, and default setting data corresponding to the threshold parameters, are stored in data storage. Electronic document data is received, as well as request data of desired settings for rendering the document on the device. Settings associated with the request data are compared to threshold parameters corresponding to the parameter data. A notification is generated upon a determination that the settings associated with the request exceed the threshold parameters. The user is then prompted relative to an alternative setting of the device. Confirmation of the acceptability of an alternative setting is received from the user. Operation of the device is enabled in accordance with alternative setting data, and a document rendering operation is performed by the document rendering device.

### BACKGROUND OF THE INVENTION

The subject application is directed generally to conservation of resources of document rendering devices. The application is particularly applicable to allowing users to override pre-selected resource conservation settings or to provide alternative settings after being apprised that the requested settings do not conform to pre-selected environmentally friendly settings.

Document rendering devices are commonly used in both businesses and homes. Such devices include printers, copiers, scanners, and facsimile devices. More recently, rendering devices have included more than one of these functions and are referred to as multifunction peripherals (MFPs) or multifunction devices (MFDs).

Document rendering devices include many settable parameters that affect resource utilization during a rendering operation. Such resources settings affect paper consumption, power consumption, toner consumption, ink consumption, and the like. Most devices have default settings, which default settings are readily changeable by users, including administrators or end users. Choices of default settings, or settings for a particular rendering job, are frequently made out of convenience and ignore resource usage, particularly in connection with jobs for which rendering characteristics are flexible or inconsequential.

### SUMMARY OF THE INVENTION

In accordance with one embodiment of the subject application, there is provided document rendering device resource conservation. Parameter data, corresponding to threshold parameters set as acceptable resource usage levels corresponding to each of a plurality of resources in an associated document rendering device, and default setting data, corresponding to a plurality of default settings of the document rendering device in corresponding to the threshold parameters, are stored in a data storage. Electronic document data corresponding to at least one electronic document for processing by the document rendering device is received, as well as request data corresponding to desired settings relative to the rendering of received electronic document data on the document rendering device. Settings associated with the request data are compared with threshold parameters corresponding to the parameter data. A notification is generated to the associated user upon a determination by the comparison that the settings associated with the request data exceed the threshold parameters associated with the threshold data. The user is then prompted relative to at least one alternative setting of the document rendering device in accordance with the generated notification. Confirmation data corresponding to the acceptability of the at least one alternative setting is received from the user so as to selectively generate alternative setting data corresponding thereto. Operation of the document rendering device is enabled in accordance with alternative setting data, and a document rendering operation is performed on at least one received electronic document in accordance with enabled operation of the document rendering device.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a document rendering device resource conservation system according to one embodiment of the subject application;

FIG. 2 is a block diagram illustrating device hardware for use in the document rendering device resource conservation system according to one embodiment of the subject application;

FIG. 3 is a functional diagram illustrating the device for use in the document rendering device resource conservation system according to one embodiment of the subject application;

FIG. 4 is a block diagram illustrating controller hardware for use in the document rendering device resource conservation system according to one embodiment of the subject application;

FIG. 5 is a functional diagram illustrating the controller for use in the document rendering device resource conservation system according to one embodiment of the subject application;

FIG. 6 is a block diagram illustrating the document rendering device resource conservation system according to one embodiment of the subject application;

FIG. 7 is a functional diagram illustrating the document rendering device resource conservation system according to one embodiment of the subject application;

FIG. 8 is a flowchart illustrating a document rendering device resource conservation method according to one embodiment of the subject application; and

FIG. 9 is a flowchart illustrating a document rendering device resource conservation method according to one embodiment of the subject application.

### DETAILED DESCRIPTION OF THE PREFERRED EMBODIMENT

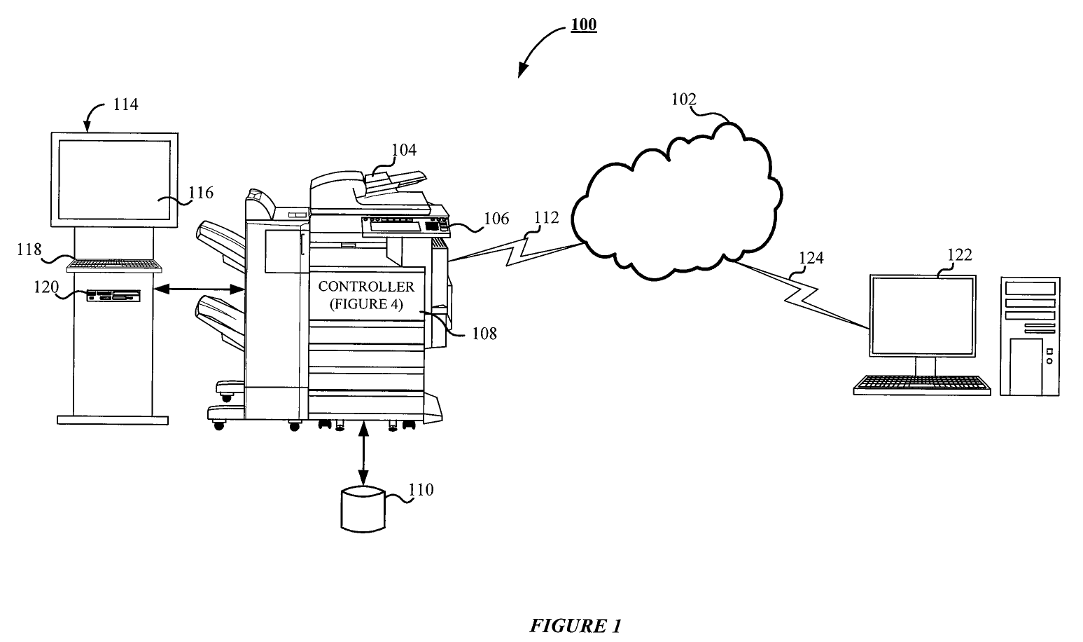

The subject application is directed to a system and method for conserving resources of document rendering devices. In particular, the subject application is directed to a system and method that allows users to override pre-selected resource conservation settings or to provide alternative settings after being apprised that the requested settings do not conform to pre-selected environmentally friendly settings. It will become apparent to those skilled in the art that the system and method described herein are suitably adapted to a plurality of varying electronic fields employing resource conservation including, for example and without limitation, communications, general computing, data processing, document processing, financial transactions, vending of products or services, or the like. The preferred embodiment, as depicted in FIG. 1, illustrates a document processing field for example purposes only and is not a limitation of the subject application solely to such a field.

Referring now to FIG. 1, there is shown an overall diagram of a document rendering device resource conservation system 100 in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document rendering device 104, which is depicted in FIG. 1 as a multifunction peripheral device, suitably adapted to perform a variety of document rendering or processing operations. It will be appreciated by those skilled in the art that such document rendering operations include, for example and without limitation, facsimile, scanning, copying, printing, electronic mail, document management, document storage, or the like. Suitable commercially-available document rendering devices include, for example and without limitation, the Toshiba e-Studio Series Controller. In accordance with one aspect of the subject application, the document rendering device 104 is suitably adapted to provide remote document rendering or processing services to external or network devices. Preferably, the document rendering device 104 includes hardware, software, and any suitable combination thereof configured to interact with an associated user, a networked device, or the like.

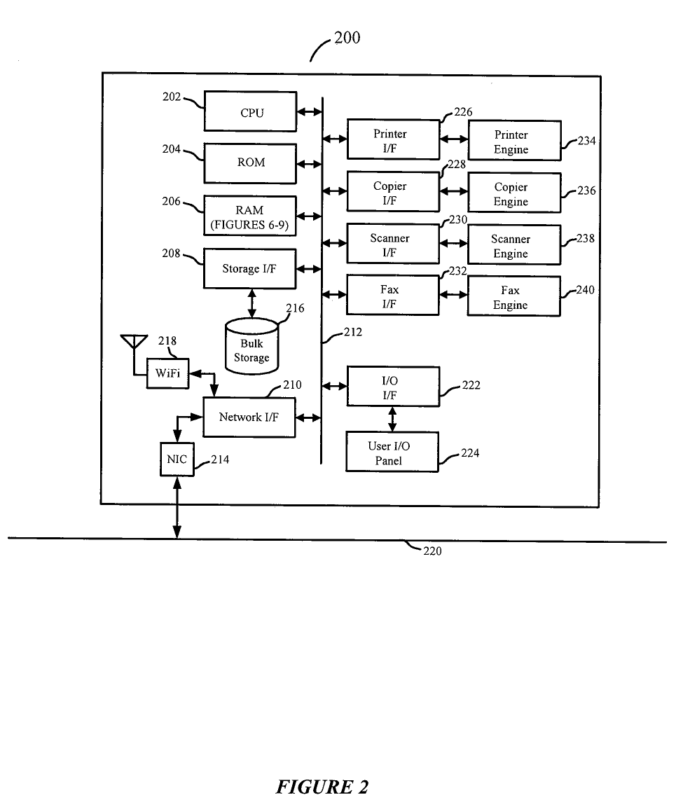

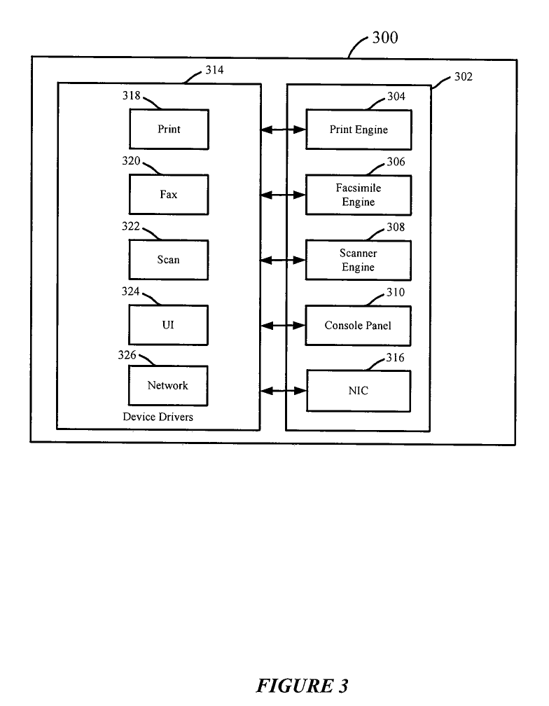

According to one embodiment of the subject application, the document rendering device 104 is suitably equipped to receive a plurality of portable storage media including, without limitation, Firewire drive, USB drive, SD, MMC, XD, compact flash, memory stick, and the like. In the preferred embodiment of the subject application, the document rendering device 104 further includes an associated user interface 106, such as a touchscreen, LCD display, touch-panel, alpha-numeric keypad, or the like, via which an associated user is able to interact directly with the document rendering device 104. In accordance with the preferred embodiment of the subject application, the user interface 106 is advantageously used to communicate information to the associated user and receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user; to receive input from the associated user; and to communicate the same to a backend component such as the controller 108, as explained in greater detail below. Preferably, the document rendering device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document rendering device 104 will be better understood in conjunction with the block diagrams illustrated in FIGS. 2 and 3, explained in greater detail below.

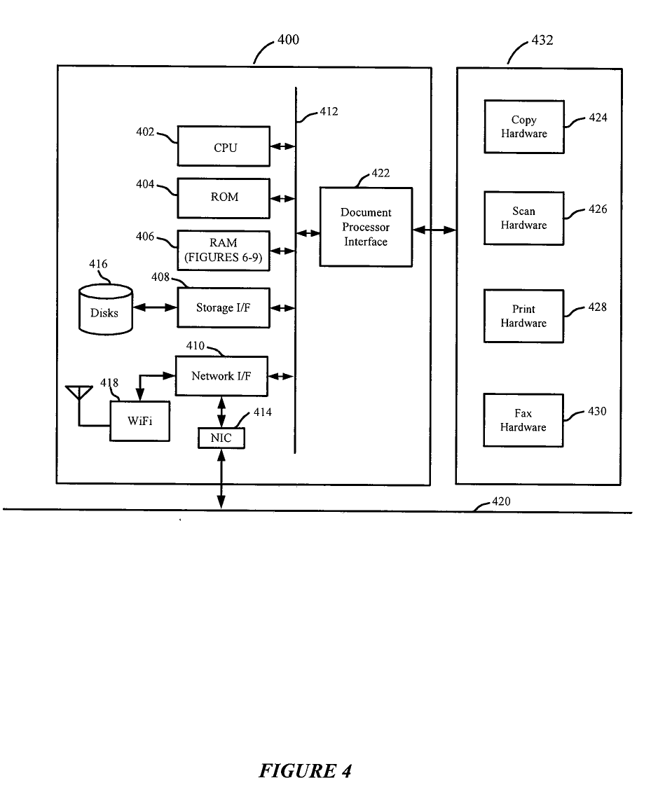

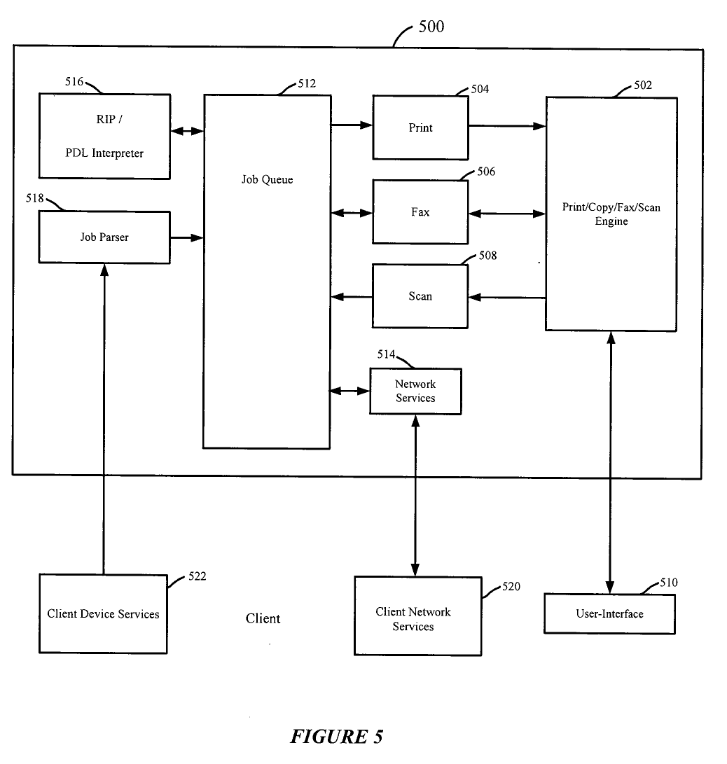

In accordance with one embodiment of the subject application, the document rendering device 104 incorporates a backend component, designated as the controller 108, suitably adapted to facilitate the operations of the document rendering device 104, as will be understood by those skilled in the art. Preferably, the controller 108 is embodied as hardware, software, or any suitable combination thereof configured to control the operations of the associated document rendering device 104, to facilitate the display of images via the user interface 106, to direct the manipulation of electronic image data, and the like. For purposes of explanation, the controller 108 is used to refer to any of the myriad components associated with the document rendering device 104, including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for document rendering device resource conservation. The functioning of the controller 108 will better be understood in conjunction with the block diagrams illustrated in FIGS. 4 and 5, explained in greater detail below.

Communicatively coupled to the document rendering device 104 is a data storage device 110. In accordance with the one embodiment of the subject application, the data storage device 110 is any mass storage device known in the art including, for example and without limitation, magnetic storage drives, hard disk drives, optical storage devices, flash memory devices, or any suitable combination thereof. In one embodiment, the data storage device 110 is suitably adapted to store scanned image data, modified image data, redacted data, user information, cellular telephone data, pre-set payment data, document data, image data, electronic database data, or the like. It will be appreciated by those skilled in the art that, while illustrated in FIG. 1 as being a separate component of the system 100, the data storage device 110 is capable of being implemented as an internal storage component of the document rendering device 104, a component of the controller 108, or the like such as, for example and without limitation, an internal hard disk drive or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

FIG. 1 also illustrates a kiosk 114 communicatively coupled to the document rendering device 104 and, in effect, to the computer network 102. It will be appreciated by those skilled in the art that the kiosk 114 is capable of being implemented as a separate component of the document rendering device 104 or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116 and a user input device 118. As will be understood by those skilled in the art, the kiosk 114 is capable of implementing a combination user input device/display such as a touchscreen interface. According to one embodiment of the subject application, the kiosk 114 is suitably adapted to display prompts to an associated user, to receive document processing instructions from the associated user, to receive payment data, to receive selection data from the associated user, and the like. Preferably, the kiosk 114 includes a magnetic card reader, conventional bar code reader, or the like suitably adapted to receive and read payment data from a credit card, coupon, debit card, or the like.

The system 100 of FIG. 1 also includes a portable storage device reader 120, coupled to the kiosk 114, which is suitably adapted to receive and access myriad different portable storage devices. Examples of such portable storage devices include, for example and without limitation, flash-based memory such as SD, xD, memory stick, compact flash, CD-ROM, DVD-ROM, USB flash drives, or other magnetic or optical storage devices, as will be known in the art.

Depicted in FIG. 1 is an administrative device 122, illustrated as a personal computer in data communication with the computer network 102 via a communications link 124. It will be appreciated by those skilled in the art that the administrative device 122 is shown in FIG. 1 as a computer workstation for illustration purposes only. As will be understood by those skilled in the art, the administrative device 122 is representative of any personal computing device known in the art including, for example and without limitation, a laptop computer, a workstation computer, a personal data assistant, a web-enabled cellular telephone, a smart phone, a proprietary network device, or other web-enabled electronic device. The communications link 124 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the administrative device 122 is suitably adapted to provide default setting/configuration data, resource restrictions, resource utilization data, status data, job data, user interface data, and/or image data; to monitor document processing jobs; to employ thin-client interfaces; to generate display data; to generate output data; or the like with respect to the document rendering device 104 or any other similar device coupled to the computer network 102.

Turning now to FIG. 2, illustrated is a representative architecture of a suitable device 200, shown in FIG. 1 as the document rendering device 104, on which operations of the subject system are completed. Included is a processor 202 suitably comprised of a central processor unit. However, it will be appreciated that the processor 202 may advantageously be composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive, and the like as shown as 216, as well as any suitable storage medium as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document rendering device 104, for use in connection with the disclosed system. FIG. 3 illustrates suitable functionality of the hardware of FIG. 2 in connection with software and operating system functionality, as will be appreciated by one of ordinary skill in the art. The document rendering device 300 suitably includes an engine 302, which facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine 302 also comprises an interface 316 with a network via driver 326 suitably comprised of a network interface card. It will be appreciated that a network thoroughly accomplishes that interchange via any suitable physical and non-physical layer such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document rendering device 104, which includes the controller 400 of FIG. 4 (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supply data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

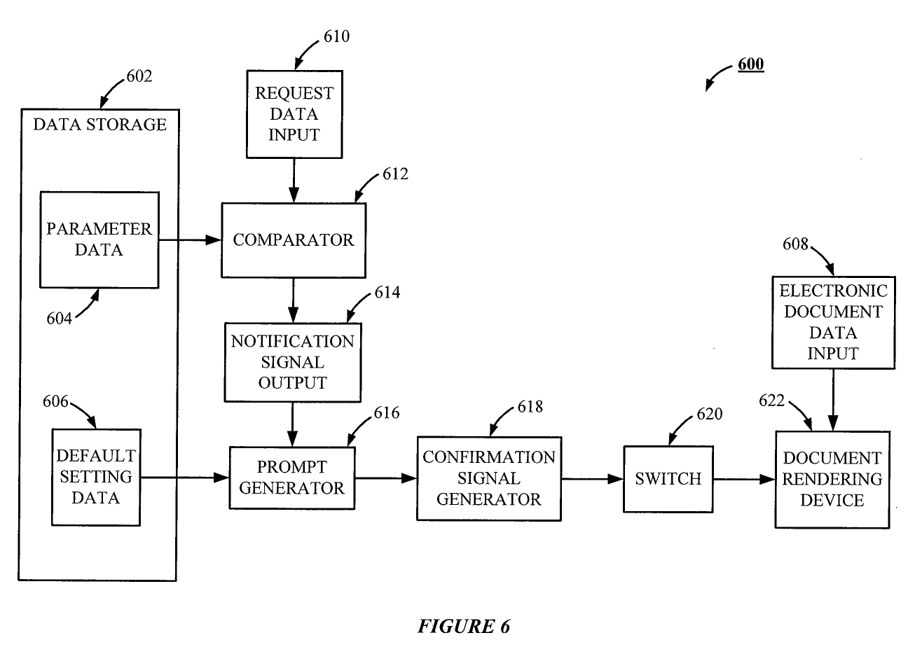

Turning now to FIG. 6, illustrated is a block diagram of a document rendering device resource conservation system 600 in accordance with one embodiment of the subject application. The system 600 includes a data storage 602, in which are stored parameter data 604 and default settings data 606. In accordance with one embodiment of the subject application, the parameter data 604 corresponds to threshold parameters set as acceptable resource usage levels corresponding to each of a plurality of resources in an associated document rendering device 622. Preferably, the default settings data 606 corresponds to a plurality of default settings of the document rendering device 622 that correspond to the threshold parameters. The system 600 also includes an electronic document data input 608 corresponding to at least one electronic document for processing by the document rendering device 622.

The system 600 depicted in FIG. 6 also incorporates a request data input 610 that is configured to receive request data from an associated user corresponding to desired settings relative to the rendering of the received electronic document data on the document rendering device 622. A comparator 612 is also included in the system 600 and is configured as operable on settings associated with request data relative to threshold parameters corresponding to the parameter data 604. A notification signal output 614 is implemented in the system 600 so as to be operable on an output of the comparator 612 upon an indication that the settings associated with the request data exceed the threshold parameters associated with the threshold data.

The system 600 further comprises a prompt generator 616 configured to be operable in accordance with an alternative setting of the document rendering device 622 and the generated notification from the notification signal output 614. According to one embodiment of the subject application, the default setting data 606 is used by the prompt generator 616 in conjunction with the notification signal so as to provide alternative settings of the document rendering device 622 to the user. The system 600 of FIG. 6 also employs a confirmation signal generator 618 operable upon acceptability of the at least one alternative setting, e.g. acceptance by an associated user. A switch 620 is also implemented by the system 600 and is configured to enable operation of the document rendering device 622 in accordance with alternative setting data. Thereafter, the document rendering device 622, when enabled by the switch 620, is operable on at least one received electronic document received via the electronic document data input 608.

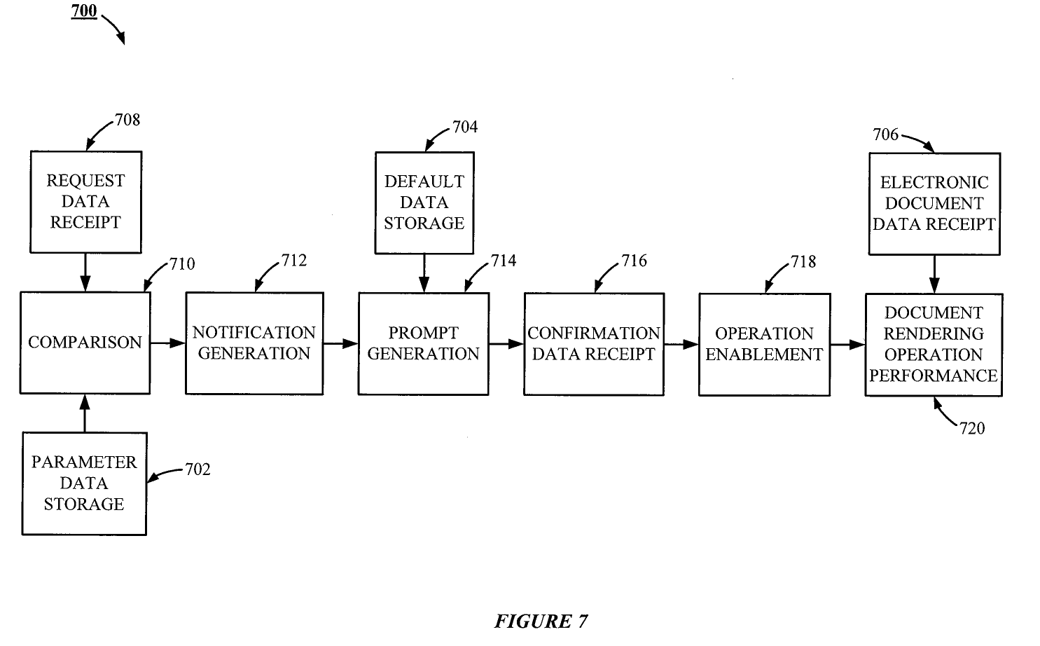

Referring now to FIG. 7, there is shown a functional diagram 700 illustrating the document rendering device resource conservation system in accordance with one embodiment of the subject application. Parameter data storage 702 first occurs in associated data storage of threshold parameters set as acceptable resource usage levels corresponding to each of a plurality of resources in an associated document rendering device 104. Next, default data storage 704 is performed on default setting data corresponding to default settings of the document rendering device 104 corresponding to the threshold parameters. Electronic document data receipt 706 of at least one electronic document for processing by the document rendering device 104 then occurs, along with request data receipt 708 of request data corresponding to desired settings relative to rendering of received electronic document data on the document rendering device 104 from an associated user.

A comparison 710 is then performed of settings associated with the received request data 708 to threshold parameters corresponding to the stored parameter data 702. Notification generation 712 then occurs of a notification to the associated user upon a determination by the comparison 710 that the settings associated with the received request data 708 exceed the threshold parameters associated with the stored parameter data 702. Next, prompt generation 714 of a prompt to the associated user relative to at least one alternative setting of the document rendering device 104 being performed in accordance with the notification generation 712. In accordance with one embodiment of the subject application, the prompt generation 714 is performed in accordance with the default data of the default data storage 704, as will be appreciated by those skilled in the art. Confirmation data 716 is then received from the associated user. Preferably, the received confirmation data 716 corresponds to the acceptability of the at least one alternative setting so as to selectively generate alternative setting data corresponding thereto. Operation enablement 718 of the document rendering device 104 then occurs in accordance with alternative setting data. The document rendering device 104 then performs a document rendering operation 720 on at least one received electronic document 706 based upon the operation enablement 718 of the document rendering device 104.

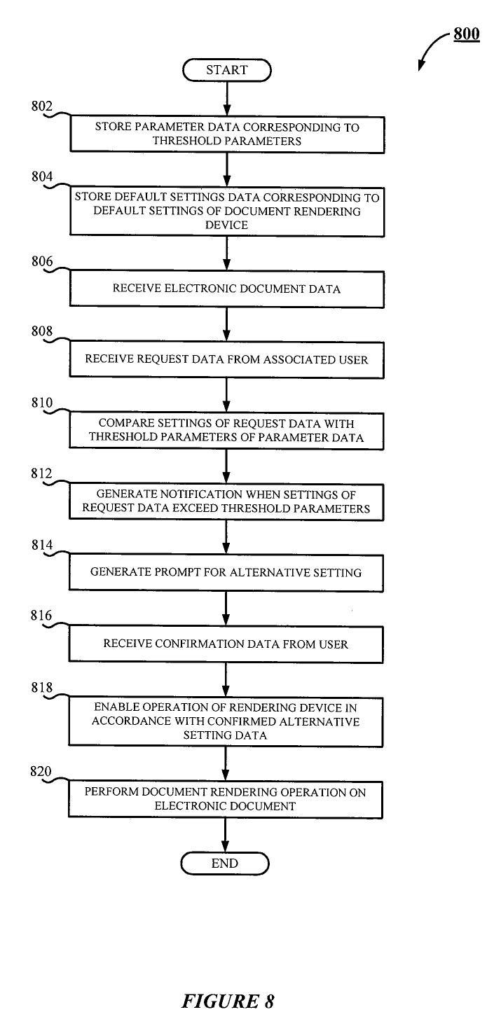

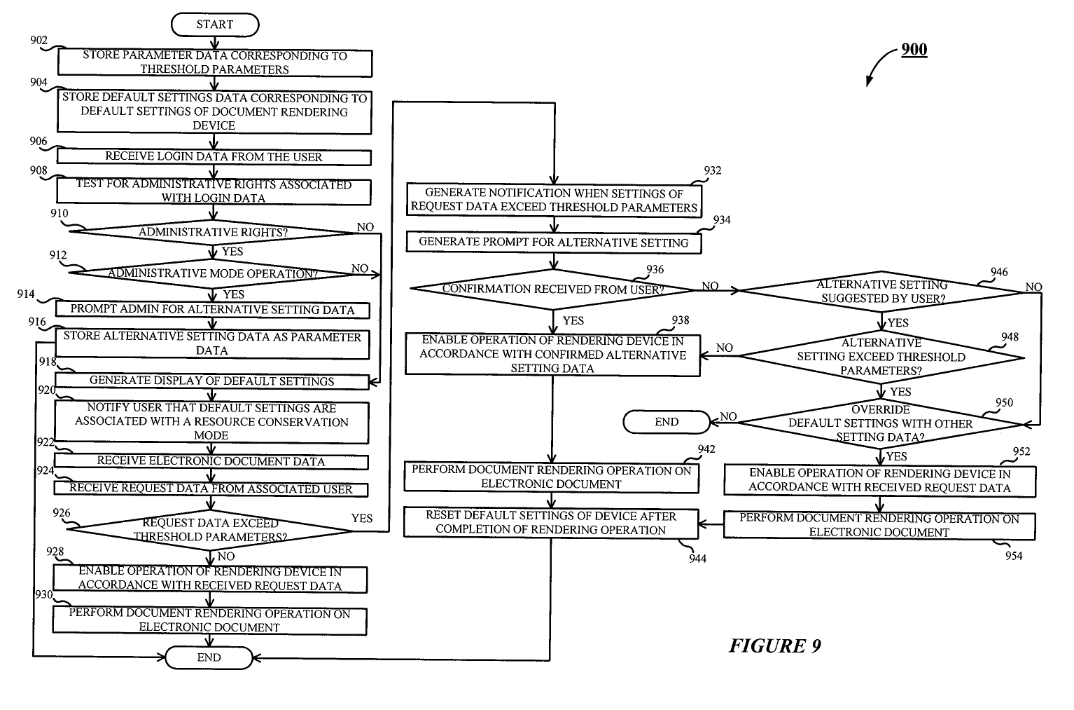

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9. Turning now to FIG. 8, there is shown a flowchart 800 illustrating a document rendering device resource conservation method in accordance with one embodiment of the subject application. Beginning at step 802, parameter data corresponding to threshold parameters set as acceptable resource usage levels corresponding to each of a plurality of resources in an associated document rendering device 104 by the controller 108 or other suitable component associated with the document rendering device 104 in the data storage device 110. Suitable threshold parameters include, for example and without limitation, blank page suppression, n-up rendering, two-sided rendering, black-and-white rendering, draft mode rendering, font size, image rendering suppression, media selection, toner saver rendering, and gray scale level. At step 804, default setting data is stored in the data storage device 110 corresponding to a plurality of default settings of the document rendering device 104 in corresponding to the threshold parameters. It will be appreciated by those skilled in the art that such parameter data and default setting data are capable of being received from the administrative device 122 or the like.

At step 806, electronic document data is received corresponding to at least one electronic document for processing by the document rendering device 104. Request data is then received by the controller 108 or other suitable component associated with the document rendering device 104 from an associated user at step 808. According to one embodiment of the subject application, the request data corresponds to desired settings relative to rendering of the received electronic document on the document rendering device 104. At step 810, settings associated with the request data are compared with threshold parameters corresponding to the parameter data by the controller 108 or other suitable component associated with the document rendering device 104. The controller 108 then generates a notification to the associated user at step 812 indicating that the comparison resulted in a determination that the settings associated with the request data exceed the threshold parameters associated with the parameter data.

A prompt is then generated at step 814 relative to at least one alternative setting of the document rendering device 104 in accordance with the generated notification. In accordance with one embodiment of the subject application, the prompt is generated to the associated user via the user interface 106, the kiosk 114, via communication to the user via a separate computing device (not shown), or the like. According to one example embodiment of the subject application, the controller 108 or other suitable component associated with the document rendering device 104 prompts the user in accordance with alternative settings based upon default settings data stored in the data storage device 110.

At step 816, confirmation data is received from the associated user corresponding to the acceptability of the at least one alternative setting. Thereafter, the controller 108 or other suitable component associated with the document rendering device 104 selectively generates alternative setting data in accordance with the confirmation data. Operation of the document rendering device 104 is then enabled at step 818 in accordance with alternative setting data. The document rendering device 104 then performs a document rendering operation on the at least one received electronic document in accordance with enabled operation at step 820.

Referring now to FIG. 9, there is shown a flowchart 900 illustrating a document rendering device resource conservation method in accordance with one embodiment of the subject application. The methodology of FIG. 9 begins at step 902, whereupon the controller 108 or other suitable component associated with the document rendering device 104 stores parameter data corresponding to threshold parameters on the associated data storage device 110. In accordance with one embodiment of the subject application, the parameter data includes data representative of blank page suppression, n-up rendering, two-sided rendering, black-and-white rendering, draft mode rendering, font size, image rendering suppression, media selection, toner saver rendering, gray scale level, and the like. It will be appreciated by those skilled in the art that such parameters are capable of being received from the administrative device 122 via the computer network 102. Preferably, such parameters are set by an administrator so as to effect the environmentally efficient operation of the document rendering device 104. At step 904, default settings of the document rendering device 104 corresponding to the threshold parameters are stored in the data storage device 110. The skilled artisan will appreciate that such settings correspond to default settings, e.g. toner usage, paper selection, etc., associated with the operations of the document rendering device 104.

At step 906, the controller 108 or other suitable component associated with the document rendering device 104 receives user login data from an associated user. It will be understood by those skilled in the art that such login data is capable of including, for example and without limitation, a username, a password, biometric data, magnetically stored data, or the like. According to one embodiment of the subject application, the login data is received via the user interface 106, the kiosk 114, or the like. The controller 108 or other suitable component associated with the document rendering device 104 then tests for administrative rights associated with the received user login data at step 908. A determination is then made at step 910 whether administrative rights are associated with the login data. Upon a positive determination at step 910, flow proceeds to step 912, whereupon the controller 108 or other suitable component associated with the document processing device 104 determines whether the associated user desires to enter into administrative mode operation, i.e. operations whereby parameter data and setting data are capable of being adjusted by the administrator.

When the associated user desires to enter the administrative mode of operation, flow proceeds from step 912 to step 914. At step 914, the controller 108 or other suitable component associated with the document rendering device 104 prompts the user via the user interface 106, the kiosk 114, or the like for alternative setting data. That is, the user is prompted to select alternative settings for operation of the document rendering device 104. The alternative setting data is then stored in the data storage 110 as parameter data at step 916. Thereafter, operations terminate with respect to FIG. 9.

When it is determined at step 910 that no administrative rights are associated with the login data or upon a determination at step 912 that an administrative mode of operation is not desired, flow proceeds to step 918. At step 918, a display of default settings associated with the operation of the document rendering device 104 is generated via the user interface 106, the kiosk 114, or the like. The user is then notified at step 920 that the default settings displayed are associated with a resource conservation mode of operation of the document rendering device 104. Electronic document data is then received at step 922 corresponding to at least one electronic document for processing by the document rendering device 104. Request data is then received from the associated user at step 924 corresponding to desired settings relative to rendering of the electronic document data on the document rendering device 104.

The controller 108 or other suitable component associated with the document rendering device 104 then compares the received request data with threshold parameters of the parameter data corresponding to the default settings of the document rendering device 104 so as to determine, at step 926, whether the request data exceeds the threshold parameters. Upon a determination that the request data does not exceed the threshold parameters, flow progresses to step 928. At step 928, the controller 108 or other suitable component associated with the document rendering device 104 enables operations of the device 104 in accordance with the settings associated with the received request data. At step 930, the document rendering device 104 performs a desired document rendering operation on the received electronic document using the settings of the request data.

Upon a determination at step 926 that the request data exceeds the threshold parameters, flow proceeds to step 932. At step 932, the controller 108 or other suitable component associated with the document rendering device 104 generates a notification to the user via the user interface 106, kiosk 114, or the like indicating that the settings of the request data exceed threshold parameters. A prompt is then generated at step 934 for at least one alternative setting by the controller 108 via the user interface 106, the kiosk 114, or the like. In accordance with one embodiment of the subject application, the controller 108 or other suitable component associated with the document rendering device 104 determines suitable conservation-conscious settings in accordance with stored parameters that enable some or all of the received settings of the request data.

A determination is then made at step 936 as to whether the user has confirmed at least one of the alternative settings displayed via the prompt. When the user has confirmed selection of one of the alternative settings, flow proceeds to step 938, whereupon the controller 108 enables operations of the document rendering device 104 in accordance with the alternative setting data. Thereafter, the document rendering device 104 performs a desired document processing operation on the received electronic document data in accordance with the alternative setting data at step 942. At step 944, the controller 108 or other suitable component associated with the document rendering device 104 then resets the document rendering device 104 to the default settings following completion of the rendering operation. That is, the conservation-conscious settings of the device 104 are restored in accordance with the default settings established by the administrator.

Upon a determination at step 936 that the user does not approve of at least one alternative setting, flow proceeds to step 946. At step 946, a determination is made by the controller 108 or other suitable component associated with the document rendering device 104 as to whether an alternative setting has been suggested by the user; that is, a determination is made as to whether the user has input alternative settings via the user interface 106, the kiosk 114, or the like. When no alternative settings have been suggested by the user, flow proceeds to step 950, whereupon a determination is made as to whether an override of the default settings has been selected by the user. Stated another way, a determination is made as to whether the user still desires to render the electronic document in accordance with the request data, e.g. non-conservation-based settings. Upon a negative determination at step 950, operations with respect to FIG. 9 terminate. When such an override has been submitted by the user at step 950, flow progresses to step 952, whereupon operations of the rendering device 104 are enabled by the controller 108 or other suitable component associated therewith in accordance with the received request data. The desired document rendering operation is then performed by the document rendering device 104 at step 954. Thereafter, the rendering device 104 is reset at step 944 to default settings and operations of FIG. 9 terminate.

When it is determined at step 946 that an alternative setting has been suggested by the user, flow proceeds to step 948, whereupon the suggested alternative setting is tested against the threshold parameters to determine whether such settings exceed the established threshold parameters. Upon a negative determination at step 948, flow returns to step 938, whereupon operations of the rendering device 104 are enabled by the controller 108 in accordance with the alternative setting data suggested by the user. The document rendering device 104 then performs the desired document rendering operation on the received electronic document at step 942 and default settings are reset on the document rendering device 104 at step 944. Upon a positive determination at step 948, flow proceeds to step 950, whereupon a determination is made as to whether the user desires to override the default setting data with other setting data, e.g. the user-suggested alternative settings or the original request data. A negative determination at step 950 results in operations of the document rendering device 104 terminating with respect to FIG. 9. A positive determination at step 950 prompts the enablement of the document rendering device 104 for document rendering operations in accordance with the suggested alternative settings at step 952. The desired document rendering operation is then performed by the document rendering device 104 at step 954, and the default settings of the device 104 are restored at step 944.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications, as are suited to the particular use contemplated. All such modifications and variations are within the scope of the subject application as determined by the appended claims when interpreted in accordance with the breadth to which they are fairly, legally, and equitably entitled.

What is claimed:

1. A document rendering device resource conservation system, comprising:
a data storage having stored therein parameter data corresponding to threshold parameters set as acceptable resource usage levels corresponding to each of a plurality of resources in an associated document rendering device;
the data storage further having stored therein default setting data corresponding to a plurality of default settings of the document rendering device that correspond to the threshold parameters;
an input for electronic document data corresponding to at least one electronic document for processing by the document rendering device;
a request data input for request data corresponding to desired settings relative to rendering of received electronic document data on the document rendering device;
a comparator operable on settings associated with request data relative to threshold parameters corresponding to the parameter data;
a notification signal output operable on an output of the comparator upon an indication that the settings associated with the request data exceed the threshold parameters associated with the threshold data;
a prompt generator operable in accordance with an alternative setting of the document rendering device and the generated notification;
a confirmation signal generator operable upon acceptability of the at least one alternative setting;
a switch operable to enable operation of the document rendering device in accordance with alternative setting data; and
a document rendering device operable on at least one received electronic document when enabled by the switch.

2. The system of claim 1, wherein the threshold parameter data includes data corresponding to at least one of blank page suppression, n-up rendering, two-sided rendering, black-and-white rendering, draft mode rendering, font size, image rendering suppression, media selection, toner saver rendering, and gray scale level.

3. The system of claim 1, further comprising:
a user login data input;
a comparator operable to determine administrative rights associated with received login data; and
alternative setting data stored in the data storage means as parameter data when the testing means indicates that the user has administrative rights.

4. The system of claim 1, wherein the associated user is a system administrator, and wherein the system further includes:
a user login data input;
a comparator operable to determine administrative rights associated with received login data; and
a document rendering device reset switch operable after completion of a document rendering operation and an output of the comparator indicative of an absence of administrative rights.

5. The system of claim 1, further comprising a display indicative of the default settings.

6. The system of claim 5, wherein the default setting display further includes information notifying the user that the settings are associated with a resource conservation mode.

7. A document rendering device resource conservation method, comprising the steps of:
storing in a data storage parameter data corresponding to threshold parameters set as acceptable resource usage levels corresponding to each of a plurality of resources in an associated document rendering device;
storing in the data storage default setting data corresponding to a plurality of default settings of the document rendering device in corresponding to the threshold parameters;
receiving electronic document data corresponding to at least one electronic document for processing by the document rendering device;
receiving from an associated user request data corresponding to desired settings relative to rendering of received electronic document data on the document rendering device;
comparing settings associated with the request data to threshold parameters corresponding to the parameter data;
generating a notification to the associated user upon a determination by the comparison that the settings associated with the request data exceed the threshold parameters associated with the threshold data;
generating a prompt to the associated user relative to at least one alternative setting of the document rendering device in accordance with the generated notification;
receiving from the associated user confirmation data corresponding to acceptability of the at least one alternative setting so as to selectively generate alternative setting data corresponding thereto;
enabling operation of the document rendering device in accordance with alternative setting data; and
performing a document rendering operation on at least one received electronic document in accordance with enabled operation of the document rendering device.

8. The method of claim 7, wherein the threshold parameter data includes data corresponding to at least one of blank page suppression, n-up rendering, two-sided rendering, black-and-white rendering, draft mode rendering, font size, image rendering suppression, media selection, toner saver rendering, and gray scale level.

9. The method of claim 7, further comprising the steps of:
receiving login data from the user;
testing for administrative rights associated with received login data; and
storing the alternative setting data in the data storage as parameter data when an output of the testing step indicates that the user has administrative rights.

10. The method of claim 7, wherein the associated user is a system administrator, and wherein the method further includes the steps of:
receiving login data from the user;
testing for administrative rights associated with received login data; and
resetting default settings of the document rendering device after completion of a document rendering operation when an output of the testing step indicates that the user does not have administrative rights.

11. The method of claim 7, further comprising the step of generating a display representative of the default settings.

12. The method of claim 11, wherein the default setting display includes a display including information notifying the user that the settings are associated with a resource conservation mode.

13. A document rendering device resource conservation system, comprising:
data storage means adapted for storing parameter data corresponding to threshold parameters set as acceptable resource usage levels corresponding to each of a plurality of resources in an associated document rendering device;
the data storage means further including means adapted for storing default setting data corresponding to a plurality of default settings of the document rendering device in corresponding to the threshold parameters;
means adapted for receiving electronic document data corresponding to at least one electronic document for processing by the document rendering device;
means adapted for receiving from an associated user request data corresponding to desired settings relative to rendering of received electronic document data on the document rendering device;
comparison means adapted for comparing settings associated with the request data to threshold parameters corresponding to the parameter data;
means adapted for generating a notification to the associated user upon a determination by the comparison means that the settings associated with the request data exceed the threshold parameters associated with the threshold data;
means adapted for generating a prompt to the associated user relative to at least one alternative setting of the document rendering device in accordance with the generated notification;
means adapted for receiving from the associated user confirmation data corresponding to acceptability of the at least one alternative setting so as to selectively generate alternative setting data corresponding thereto;
means adapted for enabling operation of the document rendering device in accordance with alternative setting data; and
means adapted for performing a document rendering operation on at least one received electronic document in accordance with enabled operation of the document rendering device.

14. The system of claim 13, wherein the threshold parameter data includes data corresponding to at least one of blank page suppression, n-up rendering, two-sided rendering, black-and-white rendering, draft mode rendering, font size, image rendering suppression, media selection, toner saver rendering, and gray scale level.

15. The system of claim 13, further comprising:
means adapted for receiving login data from the user;
testing means adapted for testing for administrative rights associated with received login data; and
means adapted for storing the alternative setting data in the data storage means as parameter data when the testing means indicates that the user has administrative rights.

16. The system of claim 13, wherein the associated user is a system administrator, and wherein the system further includes:
means adapted for receiving login data from the user;
testing means adapted for testing for administrative rights associated with received login data; and
means adapted for resetting default settings of the document rendering device after completion of a document rendering operation when the testing means indicates that the user does not have administrative rights.

17. The system of claim 13, further comprising means adapted for generating a display representative of the default settings.

18. The system of claim 17, wherein the default setting display includes a display including information notifying the user that the settings are associated with a resource conservation mode.
